(19) United States
(12) Patent Application Publication
(10) Pub. No.: US 2017/0218255 A1
(43) Pub. Date: Aug. 3, 2017

(54) Fluid Composition for Solubilizing Deposits and Incrustrations and Use of the Composition

(71) Applicant: Oxiteno S.A. Industria e Comercio, São Paulo (BR)

(72) Inventors: Olívia Cueva Candido POLTRONIERI, São Paulo (BR); Carlos Roberto TOMASSINI, Santo André (BR); Paulo de Jesus CUNHA FILHO, São Paulo (BR); Nádia Andrade ARMELIN, Cambuci (BR); Guilherme Bazzeggio da FONSECA, Arujá (BR); Juliane Pereira dos SANTOS, Santo André (BR); Fábio ROSA, Santo André (BR)

(21) Appl. No.: 15/500,406

(22) PCT Filed: Jul. 17, 2015
(86) PCT No.: PCT/BR2015/050096

§ 371 Date: Jan. 30, 2017

(30) Foreign Application Priority Data
Jul. 31, 2014 (BR) BR1020140189068

(51) Int. Cl. C09K 8/524; E21B 37/06

(52) U.S. Cl. CPC C09K 8/524; E21B 37/06

(57) ABSTRACT

The deposition of organic materials originating from crude oil, such as asphaltenes and paraffins, is deemed to compromise satisfactory oil exploration and production, because it clogs pores and equipment, compromising the operation performance. This problem may arise at various points during the operations of drilling, stimulating, fracturing, completing and cementing wells, production, transportation, refining and storage of oil and derivatives, including the use of the fluid in treatments for oil wells and reservoirs, well tubing and annuli, tubing, equipment, and tanks used in treatment processes, transportation and refining of oil and derivatives thereof. The present invention relates to a solvent composition to solubilize such deposits and incrustations. The solvents used in the present invention have a high capacity to solubilize the molecules of asphaltenes and paraffins, forming sufficiently fluid and stable solutions, which allow the use of this composition for the removal of organic deposits in the oil industry. Due to its good performance in the solubilization of deposits and incrustations and, especially, due to the biodegradable nature and superior toxicological profile, the alternatives described in the present invention can replace compositions containing benzene, toluene, ethylbenzene, and xylene (products commonly denoted as “BTEX”), diesel, kerosene, or other solvents and complex formulations used in the oil industry.

### FIELD OF THE INVENTION

The present invention relates to a solvent composition as well as to its use to remove deposits and incrustations. In particular, this invention describes a solvent composition free of or with a low content of aromatics, and high biodegradability for solubilizing asphaltenes and paraffins and other oil-derived organic deposits, and its use to remove said deposits in the oil industry.

### BACKGROUND OF THE INVENTION

The deposition of organic materials originating from crude oil, such as asphaltenes and paraffins, is deemed to compromise satisfactory exploration and production of oil. Records show that severe asphaltene deposits can stop oil production, requiring the use of mechanical processes and, in some cases, even well re-drilling (Kelland, 2014). The deposition of organic materials can occur at various points from extraction from the reservoir, which may cause obstruction in rock pores, affecting significantly the production of the well, to pipes and equipment during transport of crude oil and fluids, such as pipes, valves and pumps in both platforms and refineries, and can cause pressure drops in lines, favor other deposits, the formation of sites favorable to corrosion and, in the worst cases, prevent runoff.

Several techniques are employed in the oil industry to tackle this problem. The most common preventive technique is the use of paraffin and asphaltene inhibitors in which chemicals are injected to ensure that such organic compounds remain stable in suspension in crude oil. Another technique is the use of dispersants, which are chemicals added to break the paraffin deposits in smaller particles, so that they can be reintegrated into the oil stream. However, inhibitors and dispersants are designed to operate within specific runoff conditions, and possible disturbances can cause destabilization of the system and inefficiency of the inhibitor or dispersant, resulting in the precipitation of organic deposits. Therefore, although the industry has been employing increasingly the use of such inhibitors and dispersants, in many cases the non-definitive nature of these solutions will make the use of remediation techniques necessary, the main one being the treatment with paraffin and asphaltene dissolvers or solubilizers.

In the past, a widely-used technique was the introduction of heated crude oil above the melting point of paraffins and asphaltenes and the recirculation in the well annulus between injectors and producers. This method is extremely expensive as it requires heating large quantities of crude oil, and poses risks of fire and explosion risks in the reservoirs where the oil has a low flash point (US 2014/0121137).

Other techniques consist in an adaptation of the above solution in which crude oil is replaced by other heated fluid systems, which may contain acid, water, and aromatic solvents. U.S. Pat. No. 3,930,539 provides a reactive treatment method of organic deposits, in which the heat released by the reaction between the hydrochloric acid and phosphoric acid with ammonia allows solubilizing the paraffin while disintegrating the rock formation. Not only does this solution pose risk to the well operator, but it does not even address the issue of asphaltene deposits. U.S. Pat. No. 4,836,283, U.S. Pat. No. 6,592,279, and U.S. Pat. No. 7,296,627 also propose techniques that directly or indirectly use heat, acid, or electrolytic methods to solve the problem. U.S. Pat. No. 4,813,482, U.S. Pat. No. 5,909,774 and U.S. Pat. No. 6,112,814 relate, in turn, to complex solutions for the treatment of organic deposits where fluids are injected in defined sequences, or contain surfactants in their compositions. Such complexity explains, in part, the industry preference to use aromatic solvents, mainly xylene, and mixtures thereof, in the solubilizing processes of asphaltenic and paraffinic deposits. However, given the questionable toxicological profile of elements such as benzene, toluene, ethylbenzene and xylene (products commonly referred to as BTEX), the use of such components has been increasingly avoided by companies seeking responsible performance and reducing their employees' level of exposure to these solvents, and such trend has also been observed with the service companies of the oil and gas exploration and production industry.

Furthermore, most of the used fluid leaves the reservoir hydrophobic, which is detrimental to subsequent acidification treatments (using aqueous acid solutions). U.S. Pat. No. 4,278,129 provides elementary examples of tertiary stimulation treatments that can be applied in oil wells after primary and secondary recovery, in which aqueous solutions of anionic surfactants, such as alkoxylated and phosphates esters, are used to change the wettability of the rock, and thus increase oil mobility during formation. Such tertiary recovery methods have become increasingly common, thus being a general interest of the industry the existence of treatments for cleaning and solubilizing asphaltenic and paraffinic deposits which are capable to provide hydrophilic character to the rock.

The evolution of the theme towards friendlier formulations has been shown in U.S. Pat. No. 8,695,707, which proposes a method for removing organic deposits using at least two polar solvents and an apolar one, which may contain asphaltene inhibitors. This patent (U.S. Pat. No. 8,695,707) explores the theme based on the polar or apolar character of solvents to ensure satisfactory solubilization of different organic solutes. However, U.S. Pat. No. 8,695,707 is limited to an at least ternary solvent system, and, this patent clearly does not enable the achievement of a solution free of aromatics and containing biodegradable components providing the desired performance, since it uses solvents such as cyclohexanone or N-methyl-2-pyrrolidone (NMP) and kerosene, the latter being an oil fraction that typically contains 15 to 20% of free aromatic such as BTEX in its composition.

Considering the state of the art, it is clear the industry still needs compositions for treating deposits and incrustations that involve low thermal or mechanic energy consumption, that are acid free, compatible with aqueous system and fluids for treating secondary recovery and, mainly, compositions of biodegradable and with low content fluids of questionable toxicological profile, in particular free of aromatic hydrocarbons such as BTEX. Within this context, the present invention aims to address these matters, proposing compositions having low complexity and best toxicological and environmental characteristics.

### SUMMARY OF THE INVENTION

The present invention relates to a solvent composition for the solubilization of deposits and incrustations, including, but not limited to, asphaltenes and paraffins. The solvents used in this invention exhibit a high power to solubilize the molecules of asphaltenes and paraffins, forming sufficiently fluid and stable solutions that allow the use of this composition to remove the organic deposit in the oil industry, such as well cleaning by the process of injecting the fluid containing the cited solvents, solubilization and deposit removal. Due to the good technical performance and. above all, to the biodegradability and toxicological profile of the used solvents, the composition formulated according to this invention will find application in the place of compositions containing benzene, toluene, ethylbenzene and xylene (products commonly known as BTEX), diesel, kerosene or other solvents and complex formulations used in the industry.

### DETAILED DESCRIPTION OF THE INVENTION

For purposes of interpretation in the present invention, for ‘aromatic solvents’ we mean all the solvents that have at least one aromatic ring in their structure. Free aromatic solvents designate solvents or solvents compositions that contain at least one of the compounds benzene, toluene, ethyl-benzene or xylene (products commonly designated as BTEX). As ‘oxygenated solvents’ we mean all the solvents that have at least one oxygen atom in their molecule. Treatment fluids are used in the industry in a remediation manner, aiming at solubilizing deposits and incrustations and, more specifically, oil-derived organic deposit, such as paraffins and asphaltenes.

### Solubilization of Asphaltenes, Paraffins and Other Organic Deposits

In the exploration and handling of crude oil, organic materials naturally present in petroleum can precipitate, depositing in pores of rocks, pipes, and equipment. The main organic deposits referred to in this invention include asphaltenes and paraffins. Asphaltene has a complex and non-homogeneous molecular structure containing aromatic rings, heteroatoms and aliphatic chains combined to form various types of molecular structures. Paraffins are saturated aliphatic compounds having chains higher than C₂₀, which may or may not contain branching.

When attempting to replace the apolar solvents and especially the aromatic solvents traditionally used to solubilize these organic deposits, there is a challenge for the determination of the most effective solvents and their optimal concentration in the composition of an effective treatment fluid.

The present invention proposes the inclusion of oxygenated solvents and its combinations as candidates for solving the problem of organic deposits. Solvents and formulations traditionally containing free aromatics (BTEX) are then replaced by compositions comprising BTEX-free polar solvents, or substituted by compositions comprising at least one apolar solvent with low aromatic content or free of aromatics and a BTEX-free polar solvent, such combinations being chosen and determined according to the concepts of solvency power and compatibility.

Polar solvents according to the present invention that will provide the composition with solubility properties that are acceptable and comparable with the ones of compositions commonly found in the industry, are preferably oxygenated solvents, that is, characterized by containing at least one oxygen atom in their molecules. Preferably, the polar solvent has physico-chemical characteristics according to the data of Table 1.

TABLE 1
Physico-chemical properties of the oxygenated solvents

| Propriety | Value |
|---|---|
| Boiling Point (° C.) | 112-300° C. |
| Density (20/20° C.) | 0.9-1.3 |
| Solubility in water @ 20° C. (% by weight) | 0.9-100 |
| Flash point (closed vessel, ° C.) | 30-140 |

The information provided in Table 1, when interpreted alone, are not enough to suggest that the oxygenated solvents can be used alone or in combination with any apolar solvent with low aromatic content or free of aromatics, in compositions for the solubilization of deposits and incrustations in the oil industry, in place of the traditionally-used aromatic solvents. Moreover, the molecular structure of this solvent family clearly differs from the one of xylene and of the other solvents commonly used for this application. Thus, the finding that the oxygenated solvents exhibit suitable properties and, in preferred embodiments of the invention, provide surprisingly superior performance in the application described in this invention is an advance in the art.

The oxygenated solvents used in this invention are not listed as carcinogenic by several environmental agencies, such as IARC (International Agency for Research on Cancer), NTP (National Toxicology Program—USA), OSHA (Occupational Safety and Health Administration—USA) and ACGIH (American Conference of Governmental Industrial Hygienists). Therefore, the use of solvents belonging to the family of oxygenated solvents to replace BTEX in applications for deposit and incrustation solubilization in the oil industry enables safer levels of workers' exposure to treatment fluids, which is, thus, a significant advance in health, safety, and environmental conditions.

The composition described in this invention meets corrosion standards and is compatible with materials commonly used in the oil industry. Such solution showed satisfactory results in the solubilization of asphaltenes and paraffins when compared to commonly used aromatic solvent-based fluids, and superior performance with respect to ternary solvent compositions containing aromatics. Finally, the solvents used in the present invention have conferred upon said fluids additional characteristics that improve the performance of the compositions and assist in the application of the technique, such as (i) increasing the hydrophilic character of the compositions if compared with the use of aromatic compositions, enabling better compatibility in the intervention processes of subsequent well that require the rock to have a hydrophilic character, (ii) reducing or eliminating aromatic components in the compositions, making handling and storage possible with more safety and less exposure to compounds of questionable toxicological profile such as BTEX, (iii) increasing the composition biodegradability by using solvents containing functional groups with higher biodegradability than that of aromatic solvents, such as esters.

### Composition Free of Free Aromatics Containing Polar Solvents

The composition according to this invention is free of free aromatics (that is, BTEX), and can solubilize deposits, incrustations, asphaltenes and paraffins typically found in the oil industry in a number of steps, such as, but not limited to: drilling, stimulation, fracturing, completing and cementing of wells, production, transportation, refining and storage of oil and derivatives.

In a detailed description of the invention, the composition has the following characteristics:

a) it contains at least one polar solvent;

b) it is free of apolar solvents;

c) it has aromatic solvents (solvents that have at least one aromatic ring in their structure), in a content from 0% to 40% by weight of the total composition;

D) it is free of free aromatics (that is, BTEX); and,

d) it is free of water and/or acids.

In a detailed description of the invention, at least one of the used polar solvents is preferably an oxygenated solvent (that is, a solvent characterized in that it contains at least one oxygen atom in its molecule).

In a detailed description of the invention, the oxygenated solvent is characterized in that it preferably contains at least one ester group, or an ether group, or a ketone group in its molecule, according to Formula 1:

R₁—X₁—(R₂—X₂)ₘ—R₃ (Formula 1)
where:
R₁ is independently an aliphatic chain or cyclic chain C₁₋₁₈, which may contain at least one hydroxyl or carboxyl group
R₃ is independently a hydrogen atom, an aliphatic or cyclic chain C₁₋₁₈, which may contain at least one hydroxyl or carboxyl group
X₁ and/or X₂ are independently an ether, ester, ketone, or an oxygen atom
R₂ is an aliphatic or cyclic chain C₁₋₁₈
m≧0

In a preferred description of the invention, the oxygenated solvent according to Formula 1 is an ester obtained from alcohols whose carbon chain contains from 2 to 18 carbon atoms, and thus R₁ is a chain C₁₋₁₈, X₁ an ester bond, m=0, and R₃ an aliphatic chain C₂₋₁₈.

In a preferred description of the invention, the oxygenated solvent according to Formula 1 is an ester obtained characterized by being obtained from alcohols whose carbon chain contains from 2 to 18 carbon atoms, characterized in that the alcohol has at least one branch in its structure, and therefore, R₁ is a chain C₁₋₁₈, X₁ is an ester bond, m=0, and R₃ is a branched aliphatic chain derived from alcohols such as, but not limited to, isopropyl alcohols, isobutyl alcohols, sec-butyl alcohol, isoamyl alcohols.

In another preferred description of the invention, the oxygenated solvent according to Formula 1 is an ether obtained from alcohols whose chain contains from 2 to 6 carbon atoms and, therefore, X₁ is an ether bond, R₁ a chain derived from alcohols such as, but not limited to, ethanol, propanol, butanol, or phenol.

In a detailed description of the invention, the oxygenated solvent according to Formula 1 is a glycol ether characterized in that it is obtained from the reaction of alcohols with one to three molecules of ethylene, propylene or butylene oxides, and therefore, X₁ is an ether bond, R₁ a chain derived from alcohols such as, but not limited to, ethanol, propanol, butanol, or phenol, R₂ a saturated aliphatic chain C₂₋₄, X₂ an oxygen atom, 1<m<3, and R₃ an hydrogen atom.

### Composition Free of or with Low Content of Free Aromatics Containing a Polar Solvent and Apolar Solvents

In another detailed description of the invention, the composition has the following characteristics:

a) contains a polar solvent;

a) contains at least one apolar solvent;

c) has aromatic solvents (solvents that have at least one aromatic ring in their structure), in a content from 0% to 40% by weight of the total composition;

d) is free of water and/or acids.

In a first preferred description of the invention, the used polar solvent is preferably an oxygenated solvent (that is, a solvent characterized by containing at least one oxygen atom in its molecule).

In a detailed description of the invention, the oxygenated solvent is characterized in that it preferably contains at least one ester group, or an ether group, or a ketone group in its molecule, according to Formula 2:

R₁—X₁—(R₂—X₂)ₘ—R₃ (Formula 2)
where:
R₁ is independently an aliphatic chain or cyclic chain C₁₋₁₈, which may contain at least one hydroxyl or carboxyl group
R₃ is independently a hydrogen atom, an aliphatic or cyclic chain C₁₋₁₈, which may contain at least one hydroxyl or carboxyl group
X₁ and/or X₂ are independently an ether, ester, ketone or an oxygen atom
R₂ is an aliphatic or cyclic chain C₁₋₁₈
m≧0

In a detailed description of the invention, the oxygenated solvent according to Formula 2 is an ester obtained from alcohols whose carbon chain contains from 2 to 18 carbon atoms, and thus R₁ is a chain C₁₋₁₈, X₁ an ester bond, m=0, and R₃ an aliphatic chain C₂₋₁₈.

In a detailed description of the invention, the oxygenated solvent according to Formula 2 is an ester obtained from alcohols whose carbon chain contains from 2 to 18 carbon atoms, characterized in that the alcohol has at least one branch in its structure, and therefore, R₁ is a chain C₁₋₁₈, X₁ is an ester bond, m=0, and R₃ is a branched aliphatic chain derived from alcohols such as, but not limited to, isopropyl alcohols, isobutyl alcohols, sec-butyl alcohol, isoamyl alcohols.

In a second preferred description of the invention, the oxygenated solvent according to Formula 2 is preferably an ether obtained from alcohols whose chain contains from 2 to 6 carbon atoms and, therefore, X₁ is an ether bond, R₁ a chain derived from alcohols such as, but not limited to, ethanol, propanol, butanol, or phenol.

In a detailed description of the invention, the oxygenated solvent according to Formula 2 is a glycol ether characterized in that it is obtained from the reaction of alcohols with one to three molecules of ethylene, propylene or butylene oxides, and therefore, X₁ is an ether bond, R₁ a chain derived from alcohols such as, but not limited to, ethanol, propanol, butanol, or phenol, R₂ a saturated aliphatic chain C₂₋₄, X₂ an oxygen atom, 1<m<3, and R₃ and hydrogen atom.

The hybrid character of the composition, which uses solvents of different polarities, allows the achievement of solubility results similar to the typical values found for apolar solvents or commonly used ternary mixtures.

In a detailed description of the invention, apolar solvents suitable for the proper functioning of the invention preferably include the ones obtained from fractions from the distillation of petroleum with boiling point between 20° C. and 400° C., preferably naphtha, kerosene, and derivatives thereof, such as, but not limited to turpentine, paraffin aliphatic hydrocarbons, olefinic aliphatic hydrocarbons, aromatic hydrocarbons, and mixtures thereof. The apolar solvent used is preferably a purified fraction of the above fractions in which the aromatic hydrocarbon content ranges from 0% to 40% by weight of the total weight of the apolar solvent. The used solvent has a flash point above 61° C.

Alternatively, other apolar solvents suitable for the proper functioning of the present invention may include those obtained preferably from natural extracts, such as, but not limited to, terpenes or essential oils, such as, but not limited to, lemon terpenes, such as, but not limited to, d-limonene and 1-limonene, as well as mixtures thereof.

In a preferred form of this invention, both apolar solvents and the polar solvent are used as major components of the dissolving composition comprising from 20 to 80% by weight relative to the total composition thereof.

The composition containing two or more low-aromatic content and biodegradable solvents described in this invention can solubilize asphaltenes, paraffins and organic deposits typically found in the oil industry in a number of steps, such as, but not limited to: well drilling, stimulation, fracturing and completion, production, transportation, refining and storage of oil and by-products.

### EXAMPLES OF ORGANIC DEPOSIT SOLUBILIZATION

The invention is now described based on the examples, which are simply illustrative and should not be meant as limiting its scope.

### Example 1—Asphaltene Solubilization Test

Solvent compositions have been formulated according to the disclosure of the present invention. Oxygenated solvents belonging to the family of pure monoesters, glycol ethers and diesters were tested in combination with each other and in combinations with apolar solvents such as kerosene and d-limonene. Such compositions have been compared with traditionally employed formulas such as xylene, kerosene, and ternary mixtures containing solvents such as n-2-methylpyrrolidone (NMP). The dissolution test used to compare the formulations was performed according to the procedure described below using, as a representative material of the asphaltene family, gilsonite—a resinous rock made of a complex combination of hydrocarbons:

1) 100 ml of the composition to be tested was bath-heated until the composition reached the temperature of 66° C.;

2) an envelope of impermeable and resistant fabric was weighed (m_{c}) and the approximate amount of 1 g of gilsonite was inserted inside it. The envelope was closed, the weight of the set (mᵢ) being later measured and recorded;

3) the set was inserted in the solvent composition to be testes, and the temperature is kept at 66° C.;

4) the sample was kept immersed for 1 h;

5) Upon immersion, the sample was withdrawn from the solution, placed in an oven for 30 minutes at 30° C. to allow solvent evaporation, and then its final mass was measured (m_{f});

6) the solubilization rate was then calculated from the Formula below:

S=100×(mᵢ−m_{f})/mᵢ

The compositions used in each test, as well as the respective obtained dissolution rates S are listed in Table 2. The prefix B indicates typical formulations of the industry, while the prefix A indexes the proposed compositions within the scope of the present invention.

TABLE 2
Solubilization of asphaltenes with different formulations at 66° C.

| | | | | | | | | | Glycolic | | Aromatic | Apolar | Polar |
|---|---|---|---|---|---|---|---|---|---|---|---|---|---|
| Test | S (%) | D-limonene | Kerosene | Xylene | NMP | Diesel | Butylglycol | Monoester | Ether | Diester | character | solvents | solvents |
| B1 | 100.0 | | | 100 | | | | | | | BTEX | 1 | 0 |
| B3 | 100.0 | | 50 | 50 | | | | | | | BTEX | 2 | 0 |
| B6 | 100.0 | 50 | 45 | | 5 | | | | | | BTEX < 40 | 2 | 1 |
| B5 | 100.0 | | | 85 | | 5 | 10 | | | | BTEX | 2 | 1 |
| A13 | 100.0 | | 50 | | | | | 50 | | | BTEX < 40 | 1 | 1 |
| A1 | 95.2 | 50 | | | | | | 50 | | | Free of | 1 | 1 |
| B2 | 94.6 | | 100 | | | | | | | | BTEX | 1 | |
| A11 | 94.2 | 20 | | | | | | 80 | | | Free of | 1 | 1 |
| A4 | 89.0 | 80 | | | | | | 20 | | | Free of | 1 | 1 |
| B4 | 86.6 | | 80 | 20 | | | | | | | BTEX | 2 | |
| A6 | 85.6 | | 80 | | | | | | 20 | | BTEX < 40 | 1 | 1 |
| A5 | 84.9 | | 80 | | | | | 20 | | | BTEX < 40 | 1 | 1 |
| A8 | 84.8 | | 20 | | | | | 80 | | | BTEX < 40 | 1 | 1 |
| A2 | 84.1 | 50 | | | | | | | 50 | | BTEX = 0 | 1 | 1 |
| A7 | 82.5 | | 80 | | | | | | | 20 | BTEX < 40 | 1 | 1 |
| A14 | 73.5 | | | | | | | 100 | | | Free of | 1 | 0 |
| A3 | 7.1 | 50 | | | | | | | | 50 | Free of | 1 | 1 |

The results of Table 2 clearly show that, with the exception of A3, all the compositions proposed in the present invention can dissolve the organic deposits of asphaltic nature at rates higher than 70%, a minimum limit compatible with the general requirement of the oil industry, wherein, among the formulations that made possible the total dissolution of the deposits (B1, B3, B6, B5 e A13), A13 is the only formulation characterized in that it is a binary formulation with an aromatic content of less than 40% by weight.

Upon comparing the results of formulations A11, and A4, it is evident the superior effect of the monoester solubilization in relation to d-limonene, since the formulation with 80% of ester shows a rate 5.2% higher in relation to the inverse formulation containing 80% of d-limonene. The formulation A11 showed a rate only 0.4% lower than formulation B2 which is formed by pure kerosene. Furthermore, all monoester and d-limonene combinations exhibited rates higher than the solubility rate of the kerosene and diesel mixture (B4), typically used in the industry.

Upon comparing the results of A5 and A8, we have verified the ester ability to perform solubilization equivalent to that of kerosene.

Formulation A14, consisting of pure monoester, although exhibited a rate 21.1% lower than the rate of pure kerosene (B2), still showed adequate performance for the purposes of treatment fluid composition since it can solubilize more than 70% of the initial deposit. A14 still has the advantage of being a composition of only one solvent, free of any aromatic solvents. Such a finding that it is possible to select an oxygenated solvent capable of composing a solution free of aromatic solvents and which is capable of solubilizing organic deposits of asphaltenic nature represents an advance in the state of the art.

Formulations A6 and A2 indicate the promising character of the glycol ether in solubilizing asphaltenes, its performance being more synergistic with kerosene than with d-limonene.

The diester did not exhibit intrinsically-favorable characteristics for solubilization, however, A7 reveals that the solvent can be included in traditional compositions without significantly compromising the performance thereof.

Compositions A1, A11 and A4 provide the advantage of being binary compositions, free of aromatic solvents, being able to dissolve the asphaltic deposits at rates higher than the dissolution rates obtained for the typical aromatic formulations such as B4. A1 further provides an advantage in relation to the use of pure kerosene (B2).

Another advantage of the proposed compositions is the fact that they contain oxygenated solvents, which are products obtained by industrial processes and at higher scale than terpenes and essential oils. Moreover, said ester is, by its nature, more biodegradable than the traditional BTEX compounds used.

### Example 2—Paraffin Solubility Test

Solvent compositions have been formulated according to the disclosure of the present invention. Oxygenated solvents belonging to the family of pure monoesters, glycol ethers and diesters were tested in combination with each other and in combinations with apolar solvents such as kerosene and d-limonene. Such compositions have been compared with traditionally employed formulas such as xylene, kerosene, and ternary mixtures containing solvents such as n-2-methylpyrrolidone (NMP). The dissolution test used to compare the formulations was performed according to the procedure described below, using paraffin wax with a melting point between 60° C. and 80° C., a material representative of the paraffins commonly found in petroleum industry operations. To characterize the solvency power of each formulation, separating it from thermophysical aspects, the tests were carried out at a temperature below the paraffin melting point, as detailed below:

1) 100 ml of the composition to be tested was bath-heated until the composition reached the temperature of 38° C.;

2) an envelope of impermeable and resistant fabric was weighed (m_{c}) and the approximate amount of 1 g of paraffin wax was inserted inside it. The envelope was closed, the weight of the set (mᵢ) being later measured and recorded;

3) the set was inserted in the solvent composition to be testes, and the temperature is kept at 38° C.;

4) the sample was kept immersed for 1 h;

5) Upon immersion, the sample was withdrawn from the solution, placed in an oven for 30 minutes at 30° C. to allow solvent evaporation, and then its final mass was measured (m_{f});

6) the solubilization rate was then calculated from the Formula below:

S=100×(mᵢ−m_{f})/mᵢ

The compositions used in each test, as well as the respective obtained dissolution rates S are listed in Table 3. The prefix B indicates typical formulations of the industry, while the prefix A indexes the proposed compositions within the scope of the present invention.

TABLE 3
Solubilization of paraffins with different formulations at 38° C.

| | | | | | | | | | Glycolic | | Aromatic | Apolar | Polar |
|---|---|---|---|---|---|---|---|---|---|---|---|---|---|
| Test | S (%) | D-limonene | Kerosene | Xylene | NMP | Diesel | Butylglycol | Monoester | Ether | Diester | character | solvents | solvents |
| B1 | 99.0 | | | 100 | | | | | | | BTEX | 1 | 0 |
| B5 | 76.1 | | | 85 | | 5 | 10 | | | | BTEX | 2 | 1 |
| A1 | 65.1 | 50 | | | | | | 50 | | | Free of | 1 | 1 |
| B3 | 62.6 | | 50 | 50 | | | | | | | BTEX | 2 | 0 |
| B4 | 61.7 | | 80 | 20 | | | | | | | BTEX | 2 | 0 |
| B2 | 61.3 | | 100 | | | | | | | | BTEX | 1 | 0 |
| A5 | 60.9 | | 80 | | | | | 20 | | | BTEX < 40 | 1 | 1 |
| A12 | 57.7 | 50 | | | | | | 50 | | | Free of | 1 | 1 |
| B6 | 56.4 | 50 | 45 | | 5 | | | | | | BTEX < 40 | 2 | 1 |
| A13 | 51.2 | | 50 | | | | | 50 | | | BTEX < 40 | 1 | 1 |
| A7 | 49.2 | | 80 | | | | | | | 20 | BTEX < 40 | 1 | 1 |
| A6 | 45.0 | | 80 | | | | | | 20 | | BTEX < 40 | 1 | 1 |
| A4 | 43.5 | 80 | | | | | | 20 | | | Free of | 1 | 1 |
| A2 | 40.0 | 50 | | | | | | | 50 | | Free of | 1 | 1 |
| A11 | 36.7 | 20 | | | | | | 80 | | | Free of | 1 | 1 |
| A14 | 36.4 | | | | | | | 100 | | | Free of | 0 | 1 |
| A8 | 33.0 | | 20 | | | | | 80 | | | BTEX < 40 | 1 | 1 |
| A3 | 22.2 | 50 | | | | | | | | 50 | Free of | 1 | 1 |

The results of compositions B1, B5 and A1 show that composition A1 shows the dissolving power closest to the aromatic formulations typically used in the industry, with the advantage that A1 is an aromatic-free binary composition in its formulation. Furthermore, A1 exhibits an improved performance when compared with the mixtures of kerosene and xylene (B3 and B4), and also when compared with pure kerosene (B2).

By comparing the solubilization results of A5 with the results of B6, the ability of the monoester to act synergistically with the apolar solvent kerosene to solubilize paraffinic deposits, surprisingly, shows a better performance than that of a ternary formulation of aromatic content lower than 40% (B6), thus allowing a binary formulation with an aromatic content of less than 40% (A5). Such a finding that it is possible to select an oxygenated solvent capable of composing a binary solution with 0 to 40% by weight of aromatic solvents and which is capable of solubilizing organic deposits of paraffinic nature represents an advance in the state of the art.

In addition, by comparing A1 solubilization results with B6 and A4 results, the fact that formulation A1 exhibits a dissolution rate of 8.7% and 21.6% higher than B6 and A4 rates, respectively, reveals the ability of the oxygenated monoester solvent to act synergistically in the solubilization of paraffins to achieve superior performance than a ternary mixture containing d-limonene (B6) or binary composition with 80% d-limonene (A4).

Formulations A6 and A2 indicate that there is potential for glycol ether to compose paraffin solubilization fluids, and its performance is more synergistic with kerosene than with d-limonene.

Formulation A7 indicates the promising character of the diester in solubilizing paraffins, however, there is a technical barrier when attempting to formulate compositions with higher ester contents by weight, combined with aliphatic solvents, since the solubility of the diester in apolar solvents is low.

Another advantage of the proposed compositions is the fact that they contain oxygenated solvents, which are products obtained by industrial processes and at higher scale than terpenes and essential oils. Moreover, said ester is, by its nature, more biodegradable than the traditional BTEX compounds used.

Therefore, the findings of Examples 1 and 2 allow us to conclude that the present invention can provide a solution to the problem of solubilization of deposits and incrustations, preferably asphaltenic and paraffinic organic deposits, proposing formulations free of BTEX and with an aromatic content lower than 40% of the total weight of its composition, consisting of at least one polar solvent, wherein the polar solvent is preferably an oxygenated solvent, the oxygenated solvent being preferably a monoester. Furthermore, the examples support the fact that the present invention can propose a composition having an aromatic content of less than 40% of the total weight of its composition, containing a polar solvent and at least one apolar solvent, the polar solvent being preferably an oxygenated solvent, so that the proposed composition exhibits a solubility power equivalent to the power of solutions typically found in the art such as xylene, kerosene and ternary formulations containing d-limonene and solvents such as N-2-methyl pyrrolidone.

1.-21. (canceled)

22. A fluid composition for solubilizing deposits and incrustations comprising:
at least one polar solvent; and
aromatic solvents in a content from 0% to 40% by weight of the total composition;
wherein the composition is free of:
apolar solvents,
free aromatics,
nitrogen compounds,
surfactants, and
water and/or fatty or synthetic acids.

23. The composition of claim 22, wherein the formulation is free of aromatic solvents.

24. The composition of claim 22, wherein at least one of the polar solvents is an oxygenated solvent.

25. The composition of claim 24, wherein the oxygenated solvent contains at least an ester group, or an ether group, or a ketone group in its molecule, according to Formula 1:
R₁—X₁—(R₂—X₂)ₘ—R₃ (Formula 1)
wherein:
R₁ is independently an aliphatic or cyclic chain C₁₋₁₈, which may contain at least one hydroxyl or carboxyl group,
R₃ is independently a hydrogen atom or an aliphatic or cyclic chain C₁₋₁₈, which may contain at least one hydroxyl or carboxyl group,
X₁ and/or X₂ are independently an ether, ester, ketone, or an oxygen atom,
R₂ is an aliphatic or cyclic chain C₁₋₁₈, and
m≧0

26. The composition of claim 25, wherein the oxygenated solvent according to Formula 1 is an ester obtained from alcohols whose carbon chain contains from 2 to 18 carbon atoms, and wherein X₁ is an ester, m=0, and R₃ is an aliphatic chain C₂₋₁₈.

27. The composition of claim 25, wherein the oxygenated solvent according to Formula 1 is an ester obtained from alcohols whose carbon chain contains from 2 to 18 carbon atoms, wherein the alcohol has at least one branch in its structure, and wherein X₁ is an ester, m=0, and R₃ is a branched aliphatic chain derived from alcohols.

28. The composition of claim 25, wherein the oxygenated solvent according to Formula 1 is an ether obtained from alcohols whose chain contains from 2 to 6 carbon atoms, and wherein X₁ is an ether, and R₁ is a chain derived from alcohols.

29. The composition according to claim 25, wherein the oxygenated solvent according to Formula 1 is a glycol ether obtained from a reaction of alcohols with one to three molecules of ethylene oxide, propylene, or butylene, and wherein X₁ is an ether, R₁ is a chain derived from alcohols, R₂ is a saturated aliphatic chain C₂₋₄, X₂ is an oxygen atom, 1<m<3, and R₃ is a hydrogen atom.

30. A fluid composition for solubilizing deposits and incrustations comprising:
one polar solvent;
at least one apolar solvent; and
aromatic solvents in a content from 0% to 40% by weight of the total composition;
wherein the composition is free of:
free aromatics,
nitrogen compounds,
surfactants, and
water and/or fatty or synthetic acids.

31. The composition of claim 30, wherein
the polar solvent is from 20% to 80% by weight of the fluid.

32. The composition of claim 30, wherein the composition is free of aromatic solvents.

33. The composition of claim 30, wherein at least one apolar solvent is obtained from petroleum distillation fractions with a boiling point between 20° C. and 400° C.

34. The composition of claim 30, wherein at least one apolar solvent is obtained from natural extracts.

35. The composition of claim 30, wherein the polar solvent is an oxygenated solvent.

36. The composition of claim 30, wherein the oxygenated solvent contains at least an ester group, or an ether group, or a ketone group in its molecule, according to Formula 2:
R₁—X₁—(R₂—X₂)ₘ—R₃ (Formula 2)
wherein:
R₁ is independently an aliphatic or cyclic chain C₁₋₁₈, which may contain at least one hydroxyl or carboxyl group,
R₃ is independently a hydrogen atom or an aliphatic or cyclic chain C₁₋₁₈, which may contain at least one hydroxyl or carboxyl group,
X₁ and/or X₂ are independently an ether, ester, ketone bond, or an oxygen atom,
R₂ is an aliphatic or cyclic chain C₁₋₁₈, and
m≧0.

37. The composition of claim 36, wherein the oxygenated solvent according to Formula 2 is an ester obtained from alcohols whose carbon chain contains from 2 to 18 carbon atoms, and wherein R₁ is a chain C₁₋₁₈, X₁ is an ester, m=0, and R₃ an aliphatic chain C₂₋₁₈.

38. The composition of claim 36, wherein the oxygenated solvent according to Formula 2 is an ester obtained from alcohols whose carbon chain contains from 2 to 18 carbon atoms, wherein the alcohol has at least one branch in its structure, and wherein R₁ is a chain C₁₋₁₈, X₁ is an ester, m=0, and R₃ is a branched aliphatic chain derived from alcohols.

39. The composition, according to claim 36, wherein the oxygenated solvent according to Formula 2 is an ether obtained from alcohols whose chain contains from 2 to 6 carbon atoms, and wherein X₁ is an ether, and R₁ is a chain derived from alcohols.

40. The composition of claim 36, wherein the oxygenated solvent according to Formula 2 is a glycol ether obtained from the reaction of alcohols with one to three molecules of ethylene oxide, propylene or butylene, and wherein X₁ is an ether, R₁ is a chain derived from alcohols, R₂ is a saturated aliphatic chain C₂₋₄, X₂ is an oxygen atom, 1<m<3, and R₃ is a hydrogen atom.

41. A method of removing deposits and incrustations in the petroleum industry comprising injecting the composition of claim 22.

42. The method of claim 41, wherein the deposits and incrustations are removed in one or more of drilling operations, stimulation, fracturing, completion and cementing of wells, production, transportation, refining and storage of oil and derivatives, including the use of the fluid reservoirs and oil wells treatments, annular and pipe wells, pipes, equipment and tanks used in treatment processes, transportation and refining of oil and its derivatives.

43. The method of claim 42, wherein the deposits and incrustations are organic deposits from the crude oil.
